(19) United States
(12) Patent Application Publication
(10) Pub. No.: US 2022/0350882 A1
(43) Pub. Date: Nov. 3, 2022

(54) DETECTION/ASSESSMENT OF AN INTRUSION INTO AN ELECTRONIC DATA SYSTEM OF A VEHICLE

(71) Applicant: Robert Bosch GmbH, Stuttgart (DE)

(72) Inventor: Paulius Duplys, Markgroeningen (DE)

(21) Appl. No.: 17/660,469

(22) Filed: Apr. 25, 2022

(30) Foreign Application Priority Data
May 3, 2021 (DE) 10 2021 204 409.3

(51) Int. Cl. G06F 21/55

(52) U.S. Cl. CPC G06F 21/552

(57) ABSTRACT

A computer-implemented method for detecting and/or assessing an intrusion into an electronic data system of a vehicle, including receiving data from each node of a set of nodes of the electronic data system of the vehicle, calculating a vehicle condition on the basis of the data, and detecting and/or assessing the intrusion into the electronic data system of the vehicle at least on the basis of the vehicle condition. A server in a network, which is designed to carry out the computer-implemented method for detecting and/or assessing an intrusion into an electronic system of the vehicle, the electronic data system of the vehicle and, optionally, each electronic data system of each further vehicle of the set of the further vehicles being connected to the network. A vehicle which includes an electronic data system which is secured according to the computer-implemented method.

### CROSS REFERENCE

The present application claims the benefit under 35 U.S.C. § 119 of German Patent Application No. DE 10 2021 204 409.3 filed on May 3, 2021, which is expressly incorporated herein by reference in its entirety.

### FIELD

Mechatronic technical systems, for example, vehicles, frequently include one or multiple electronic data systems. For example, a mechatronic technical system may include a plurality of (electronic) control units, which may interact within at least one electronic data system—for example, at least one bus system. The functionality of such a technical system is generally significantly dependent on this interaction. For example, even in a non-autonomously driving vehicle, more than a hundred (electronic) control units—for example, for engine control, transmission control, antilock braking system/vehicle dynamics control, airbag, body control unit, driver assistance systems, car alarm systems, etc.—may be networked with one another as nodes via the at least one electronic data system. The increasing digitization and automation and networking of technical systems may result in ever larger electronic data systems (i.e., having more nodes) or in combinations of multiple electronic data systems (for example, via gateways).

The controller area network (CAN), in which control units of a technical system, in particular of a vehicle, are connected via a CAN bus and may communicate with one another according to a CAN protocol, represents a known and standardized serial bus system according to the multimaster principle, in which all control units have equal rights in the CAN. For example, CAN (in the meantime in various versions) and/or CAN-inspired refinements may be used in mechatronic technical systems of all types (for example, in the automobile industry, in automation technology, in elevator systems, in medical technology, in aerospace technology, in rail vehicle construction, in shipbuilding, . . . ). Alternative communication systems and/or communication protocols to CAN and/or CAN-inspired refinements (abbreviated as CAN etc.), in particular for vehicles, are conventional in the related art.

Electronic data systems, in particular CAN etc., were and are developed in such a way that the data transfer via the CAN bus is as independent as possible of external random interferences—for example, in terms of electromagnetic compatibility (EMC). For example, the CAN bus may be implemented by two twisted wires (CAN_HIGH, CAN_LOW) and symmetrical signal transfer may thus be achieved. CAN etc. have thus proven themselves in particular also in safety-relevant fields (for example in the vehicle), in which a high level of data security is crucial. While electronic data systems, for example, CAN etc., are comparatively simple, robust, and fast (for example, by dispensing with encryption), on the other hand, they may be susceptible to targeted attacks and/or manipulations from the outside (for example, because of the multimaster principle and/or the lack of encryption).

In general, such an intrusion into the electronic data system and in particular into the bus system may include, for example, sending a message (also: frame) from an additional and non-provided node of the electronic data system or from a provided but infiltrated node of the electronic data system. Such a message may interfere with the communication of the provided nodes of the electronic data system. In particular, by targeted deception (for example by specifying an identifier of a provided node), fake messages may be sent which may negatively influence the electronic data system and/or the operation of the associated technical system, in particular the vehicle. In the course of increasing digitization (more interfaces, for example, a multimedia interface which has become typical in the vehicle), and the automation and networking of technical systems, the area of attack for a possible intrusion is growing increasingly. Securing the electronic systems against intrusion is therefore important.

Intrusion detection systems (IDS) are available in the related art, which are designed to detect an intrusion into the electronic data system on a low integration level (for example on the level of the electronic data system). Examples of such intrusion detection systems are CycurIDS from ETAS/ESCRYPT, In-vehicle Network Protection from ARGUS, or Sentinel-CAN from ARILOU. If an intrusion into the electronic data system is detected by an intrusion detection system, it may be logged, for example, in a node for documentation and later analysis. Alternatively or additionally, a user (for example, the driver or an occupant) of the technical system (for example, of the vehicle) or another service center may be informed via a user interface. Additionally or alternatively to these passive reactions, an active and a preferably immediate reaction may be desirable, in particular to prevent a manipulation of the electronic data system and/or the associated technical system (promptly). In a bus system, for example, an error message (also: error frame) may be sent on the bus and thus to all nodes of the bus system.

### SUMMARY

A first general aspect of the present invention relates to a computer-implemented method for detecting and/or assessing an intrusion into an electronic data system of a vehicle. In accordance with an example embodiment of the present invention, the method includes receiving data from each node of a set of nodes of the electronic data system of the vehicle. The method furthermore includes calculating a vehicle condition on the basis of the data. The method may furthermore include detecting the intrusion into the electronic data system of the vehicle at least on the basis of the vehicle condition. Alternatively or additionally, the method may include assessing the intrusion into the electronic data system of the vehicle at least on the basis of the vehicle condition.

A second general aspect of the present invention relates to a server in a network which is designed to carry out the computer-implemented method for detecting and/or assessing an intrusion into the electronic data system of the vehicle according to the first general aspect (or a specific embodiment thereof), the electronic data system of the vehicle and, optionally, each electronic data system of each further vehicle of the set of the further vehicles being connected to the network.

A third general aspect of the present invention relates to a vehicle which includes an electronic data system which is secured according to the computer-implemented method for detecting and/or assessing an intrusion into the electronic data system of the vehicle according to the first general aspect (or a specific embodiment thereof).

As was already described in the related art, the (prompt) detection of an intrusion into the electronic data system of the vehicle has great importance to be able to ensure safe operation of the vehicle both for the vehicle and possibly its user (for example, driver and/or occupants) and also for the surroundings of the vehicle (including, for example, further road users). As much as efforts may be made to prevent an intrusion into the electronic data system of the vehicle in principle, even in (well) secured electronic data systems, successful intrusions may occur at some time—as history shows. The reasons for this may be given, for example, in the continuous competition between technologies for securing and technologies for intruding into and/or bypassing safeguards, in particular since technical systems such as vehicles may be used for a certain operating time (for example, for 10 to 20 years). Furthermore, it may be stated that in the course of increasing digitization (more interfaces, for example, a multimedia interface which has become typical in the vehicle) and the automation and networking of technical systems, the area of attack for possible intrusion and/or for bypassing safeguards increases. It is therefore important to provide at least one (vehicle-internal or vehicle-external) intrusion detection system for the vehicle which is designed to detect intrusions into the electronic system of the vehicle. To prevent harmful interventions caused by intrusions, the intrusion detection systems are to be able to intervene and/or warn as promptly as possible.

However, the detection of the intrusion may sometimes be faulty. This may be attributed, for example, to the fact that technical systems such as vehicles and also electronic data systems typically have a high degree of complexity and e.g. could be subjected to the open context, for example as in automated driving. In addition to the possibility that an actual intrusion is not detected (this case may be referred to in as a false positive), it is also possible that a non-intrusion is incorrectly detected as an intrusion (this case may be referred to as a false negative). While a non-detected intrusion (false positive case) may indicate a malfunction of the intrusion detection system and is thus undesirable, a detected assumed intrusion (false positive case) may even destroy the functionality of the technical system, in particular of the vehicle even in the regular case (i.e., even without actual intrusion). For example, it would be unacceptable if an assumed intrusion into the vehicle were always detected when a digital smart device of a user of the vehicle connected itself via a multimedia interface to the electronic data system of the vehicle and the user was thereupon prompted to seek out service. It may therefore be important to assess an event (also: situation) identified by a (vehicle-internal and/or vehicle-external) intrusion detection system as an intrusion and be able to confirm it if necessary.

As provided in the computer-implemented method (or in specific embodiments thereof), it may therefore be advantageous in the detection and/or assessment of an intrusion to take into consideration the vehicle condition of the vehicle. An event/a situation may thus be viewed in a larger context and thus assessed better. While, as is conventional in the related art, a single control unit of an electronic data system of the vehicle may include an intrusion detection system, due to the low integration level, it is hardly capable of taking into consideration a higher-order vehicle condition, in particular since typically control units are developed and sold independently of the technical systems integrating them. In fact, for example, the same control unit may be possible for use in various vehicles, in various vehicle projects, and/or for different vehicle manufacturers (also: original equipment manufacturer, OEM). Furthermore, it may be advantageous to integrate knowledge of further control units in the detection and/or assessment of the intrusion. The context may thus also be enlarged and intrusions may be detected and/or assessed more reliably.

As furthermore provided in the computer-implemented method (or in specific example embodiments thereof), it may be advantageous to expand the context to a vehicle fleet, the vehicle fleet being able to include a plurality of vehicles, for example, of a vehicle manufacturer, a vehicle project, and/or a defined vehicle project version (in particular a defined software version). In this case, the server in the network (according to the second general aspect) may prove to be particularly useful, since data and assessments of the plurality of vehicles may be brought together via the server. On the other hand, the server in the network may also already be advantageous for a single vehicle. For example, the computing capacity and/or memory capacity in the vehicle may be limited, for example, for reasons of cost. On the server, in contrast, the (dedicated) hardware may be provided, for example, which is required for a reliable detection and/or assessment also on the basis of the data and/or the vehicle condition.

Intrusion detected and/or confirmed by the server (and, for example, proposed measures) may be transferred into the vehicle and/or into the further vehicles of the vehicle fleet. The vehicle and/or or a further vehicle may thus react promptly to the intrusion.

The server may furthermore be advantageous insofar as intrusion detection systems provided in the vehicle are often static. In fact, for example, for reasons of robustness and/or security, static rules/algorithms/data sets for detecting and/or assessing intrusion are implemented at a certain time of the development (“hard coding”), which are to be valid for the entire operating time. In addition, software updates may take place during service. The competition between safeguard and intrusion often runs faster than such service intervals, however. Technically, the option did exist of updating such rules/algorithms/data sets, for example, in a so-called over-the-air software update during operation of the vehicle. In practice, however, little or no use has been made thereof, among other things because a new area of attack would thus be offered. On the server, in contrast, new findings may be taken into consideration in the algorithms for detecting and/or assessing intrusions.

### BRIEF DESCRIPTION OF THE DRAWINGS

FIG. 1 shows an exemplary specific example embodiment of the present invention including at least one vehicle and a vehicle security incident and event management (VSIEM) system.

FIG. 2 schematically illustrates a computer-implemented method for detecting and/or assessing an intrusion in an electronic data system of a vehicle, in accordance with an example embodiment of the present invention.

FIG. 3 schematically illustrates specific embodiments of the computer-implemented method for detecting and/or assessing an intrusion in an electronic data system of a vehicle, in accordance with the present invention.

FIGS. 4A through 4E show exemplary functional dependencies for detecting and/or assessing an intrusion into an electronic data system of a vehicle, in accordance with an example embodiment of the present invention.

### DETAILED DESCRIPTION OF EXAMPLE EMBODIMENTS

Computer-implemented method 100 is directed to detecting and/or assessing an intrusion in an electronic data system of a vehicle. The security is thus to be increased or the security is also to be ensured as an area of attack becomes increasingly larger. Method 100 may also be generalized in its specific embodiments to one or a plurality of technical systems which are not necessarily vehicles, but each include at least one electronic data system.

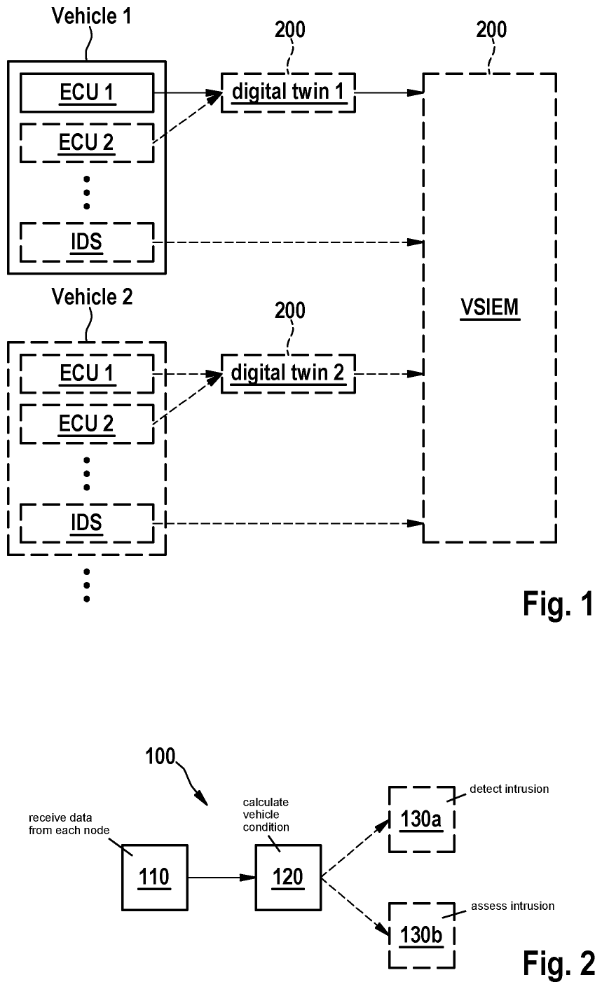

FIG. 1 visualizes how, starting from a control unit (here: ECU 1, vehicle 1) of the vehicle (here: vehicle 1), the context for detecting and/or assessing an intrusion in the electronic data system may be expanded to further nodes/control units (here: ECU 2, . . . , vehicle 1) and nodes/control units (here: ECU1, ECU2, . . . , vehicle 2, . . . ) of further vehicles. For example, from all these nodes/control units, (further) data—optionally via a (further) digital twin (here: digital twin 1, digital twin 2, . . . )—in each case—may be transferred to a Vehicle Security Incident and Event Management (VSIEM) system, which may be designed to carry out computer-implemented method 100 (or a specific embodiment thereof). The VSIEM system may be implemented on a server 200.

The vehicle and/or each further vehicle may each include an intrusion detection system (IDS) in the vehicle, which may be designed to (preliminarily) assess an intrusion. For example, a (further) anomaly status may be ascertained in each case, which is also transferred to the VSIEM system.

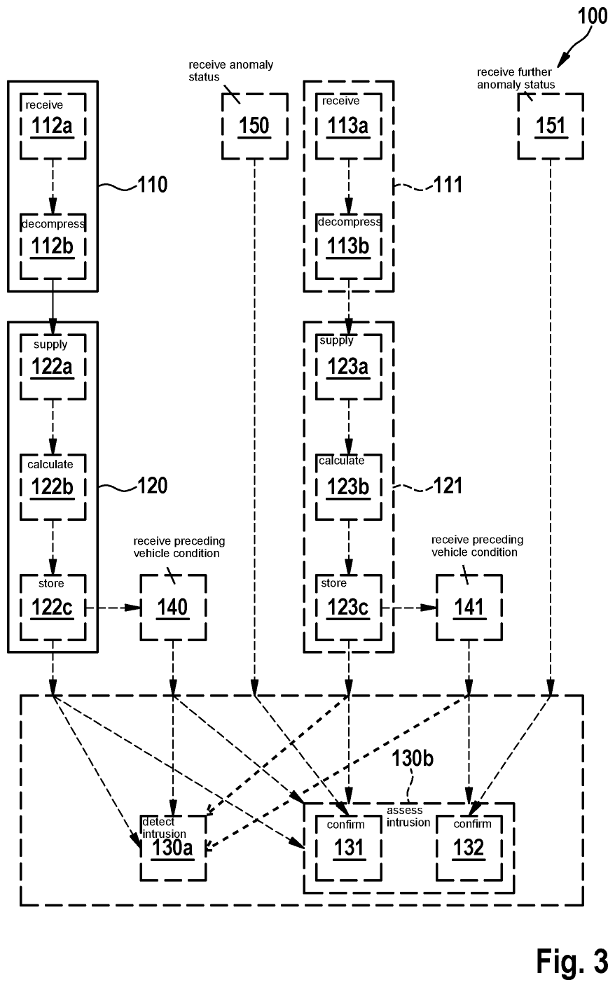

A computer-implemented method 100 is described for detecting and/or assessing an intrusion into an electronic data system of a vehicle. This means, method 100 may be a method for detecting an intrusion into an electronic data system of a vehicle. Alternatively or additionally, method 100 may be a method for assessing an intrusion into an electronic data system of a vehicle. The method may include receiving 110 data from each node of a set of nodes of the electronic data system of the vehicle. Method 100 may furthermore include calculating 120 a vehicle condition on the basis of the data. The method may furthermore include detecting 130a and/or assessing 130b the intrusion into the electronic data system of the vehicle at least on the basis of the vehicle condition. FIG. 2 schematically illustrates the computer-implemented method for detecting and/or assessing an intrusion into an electronic data system of a vehicle. Various specific embodiments of the computer-implemented method are schematically illustrated and summarized in FIG. 3.

The detection of an intrusion into the electronic data system may be based on at least one predetermined detection criterion. The at least one predetermined detection criterion may include predetermined (static) rules. Alternatively or additionally, the detection of an intrusion may be based on a classification algorithm (for example, a trained machine learning algorithm, for example, a support vector machine or an artificial neural network) and/or a regression algorithm (for example, a trained machine learning algorithm, for example, an artificial neural network). The detection of an intrusion into the electronic data system may include checking whether an anomaly/inconsistency is present in the data of at least one node of the set of nodes on the basis of the at least one predetermined detection criterion. Such a check may take place in each case at a point in time (for example, in each interrupt) during operation of the vehicle (but not necessarily in the vehicle).

The assessment of an intrusion into the electronic data system may be based on at least one predetermined assessment criterion (and/or on the at least one predetermined detection criterion). The at least one predetermined assessment criterion may include predetermined (static) rules. Alternatively or additionally, the assessment of an intrusion may be based on a classification algorithm (for example, a trained machine learning algorithm, for example, a support vector machine or an artificial neural network) and/or a regression algorithm (for example, a trained machine learning algorithm, for example, an artificial neural network). The assessment of an intrusion into the electronic data system may include checking whether an anomaly/inconsistency found may be confirmed on the basis of the data. Such a check may take place in each case at a point in time (for example in each interrupt) during operation of the vehicle (but not necessarily in the vehicle).

The at least one assessment criterion may be the at least one predetermined detection criterion.

Detecting the intrusion may already implicitly include assessing the intrusion.

The set of the nodes of the electronic data system of the vehicle may be a set of control units of the vehicle which are networked with one another via the electronic data system of the vehicle. A/each node may thus be a control unit. Alternatively (at least) one node may be an electronic device which is not necessarily a control unit. Such an electronic device therefore does not necessarily have to control a technical (sub-)system of the vehicle. The electronic data system may be/include, for example, a CAN etc. including a CAN bus. The electronic data system may also be a network of electronic data systems. For example, multiple CAN etc. may each be connected to one another via a gateway.

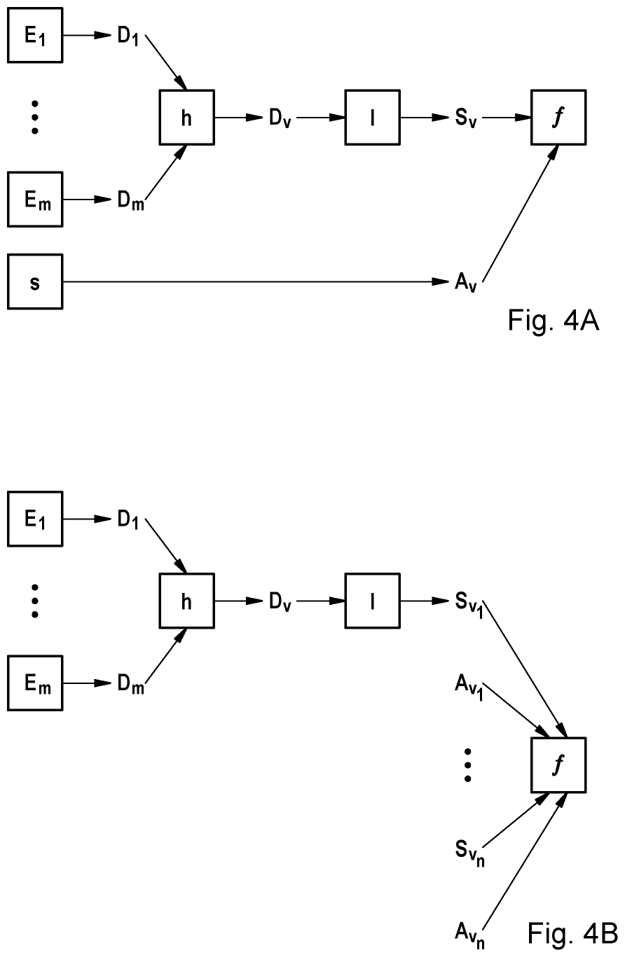

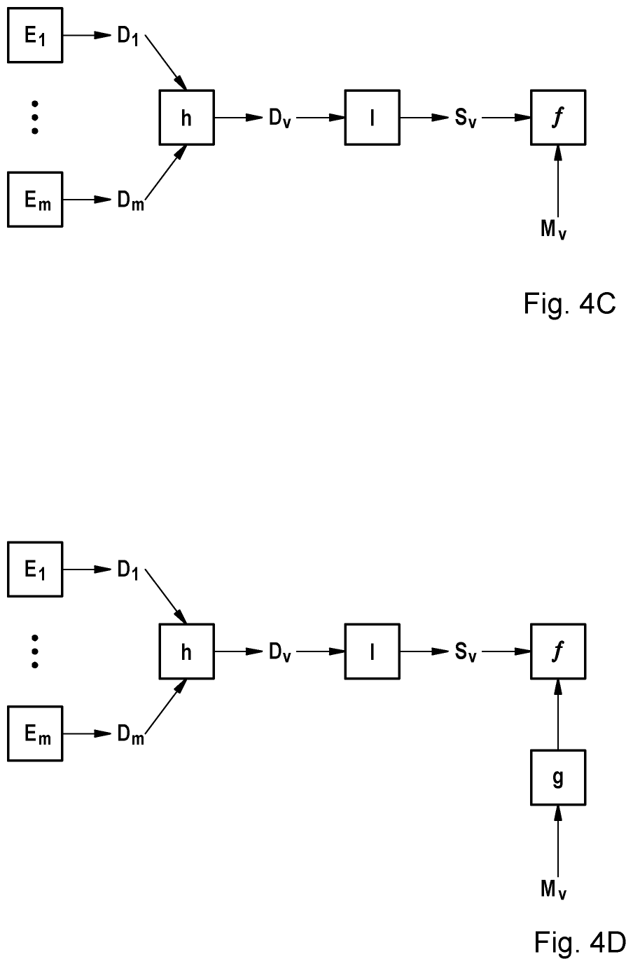

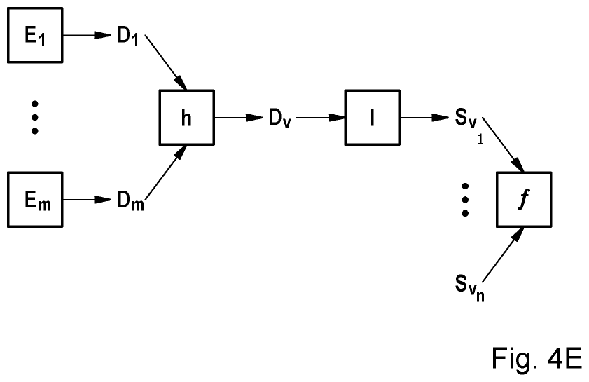

The data of each node, i.e., for example, each control unit, may include one or multiple time records (for example time series), which characterize the technical system, in particular the vehicle, and/or its surroundings. The one or multiple time records may describe, for example, pieces of information about the behavior of the vehicle and/or its surroundings (for example, further road users). A time record may be, for example, the vehicle velocity. The vehicle velocity may be used, for example, to assess whether the vehicle is driving or standing. The further data of each node, see below, may thus be in the nature of data with the proviso that they relate to a further vehicle. In FIGS. 4A through 4E, the data of a first control unit E₁ are designated as D₁, . . . the data of an mth control unit Eₘ as Dₘ.

The vehicle condition may include pieces of information which are relevant for detecting and/or assessing an intrusion. These pieces of information, except for pieces of information applying universally to vehicles (for example the vehicle velocity), may be a function of the architecture of the vehicle. These pieces of information (or part thereof) may furthermore be a function of the (specific) vehicle (for example, the software versions installed in the vehicle). The vehicle condition may include a driving condition. The pieces of information may also include, for example, the condition(s) of one or multiple nodes (control units) of the electronic data systems. The vehicle condition may be a data structure which codes the pieces of information. Alternatively or additionally, the vehicle condition may include a numeric object, for example, a number, a vector, a matrix, or a tensor. The vehicle condition may be coded as a byte or bit signal sequence. The vehicle condition of the vehicle (v) or of the first vehicle (v₁), . . . , of the nth vehicle (vₙ) in a plurality of vehicles may be expressed as a mathematical object Sᵥ or Sᵥ_{₁}, . . . , Sᵥ_{ₙ}.

Detecting 130a and/or assessing 130b the intrusion into the electronic data system of the vehicle may lead to a result which contains pieces of information about the detection and/or assessment of the intrusion. For example, the result may include a bit for intrusion/no intrusion. Alternatively or additionally, the result may include a (quasi-)continuous number (for example, in the interval of real numbers [0, 1]), which is correlated with the probability for intrusion (for example, 0 for probability 0 or 1 for probability 1). Alternatively or additionally, the result may include a bit for intrusion confirmed/intrusion not confirmed. Alternatively or additionally, the result may include measures, for example, by way of a numeric coding of routines. The result may be a data structure which codes the pieces of information. Alternatively or additionally, the result may include a numeric object, for example, a number, a vector, a matrix, or a tensor. The result may be coded as a byte or bit signal sequence.

In that detecting 130a and/or assessing 130b the intrusion into the electronic data system of the vehicle is at least based on the vehicle condition, the result may be expressed as a value of a function f, which is a function at least of vehicle condition Sᵥ of the vehicle:

f(Sᵥ)

Method 100 may furthermore include: for each further vehicle of a set of further vehicles, receiving 111 further data from each node of a set of nodes of an electronic data system of the further vehicle.

Method 100 may furthermore include: for each further vehicle of the set of further vehicles, calculating 121 a further vehicle condition on the basis of the further data of the further vehicle. Detecting 130a and/or assessing 130b the intrusion into the electronic data system of the vehicle may furthermore be based at least on at least one further vehicle condition. The set of further vehicles may be the plurality of vehicles (minus the vehicle). The (particular) further vehicle may be another vehicle from the set of further vehicles. The electronic data system of the (particular) further vehicle may (but does not have to be) structurally identical with regard to its architecture and/or data input (for example, software version). The set of nodes may be the plurality of control units. The set of nodes of the electronic data system of the further vehicle may (but does not have to) correspond to the set of nodes of the electronic data system of the vehicle.

In that detecting 130a and/or assessing 130b the intrusion into the electronic data system of the vehicle is based at least on the at least one further vehicle condition, the result may again be expressed as a function f, which is a function at least vehicle condition Sᵥ=Sᵥ_{₁} of the vehicle and the at least one further vehicle condition Sᵥ_{₂}:

f(Sᵥ_{₁},Sᵥ_{₂})

For n−1 further vehicles, with n−1>1, furthermore the following dependency may result:

f(Sᵥ_{₁},Sᵥ_{₂}, . . . ,Sᵥ_{ₙ})

Such a dependency is outlined in FIG. 4E.

The electronic data systems of the vehicle may include (or be) a control system. The control system may be, for example, a CAN, etc. At least one node of the set of nodes of the electronic data system may be an electronic control unit (ECU). The electronic control unit may be designed to control the technical system, in particular the vehicle, or to contribute to the control. The set of the nodes of the electronic data system of the vehicle may include at least two nodes (e.g., 2, 3, 4, 5, >5, >10, >20, >50, >100, >200). The set of the nodes of the electronic data system of the (particular) further vehicle may also include at least two nodes (e.g., 2, 3, 4, 5, >5, >10, >20, >50, >100, >200). The set of the further vehicles may include at least one further vehicle (e.g., 1, >1, >5, >10, >100, >1e3, >1e4, >1e5, >1e6).

Calculating 120 the vehicle condition on the basis of the data may, as schematically shown in FIG. 3, include supplying 122a the data into a digital twin of the vehicle. Calculating 120 may furthermore include calculating 122b the vehicle condition by way of the digital twin. Calculating 120 may furthermore include storing 122c the vehicle condition in the digital twin.

For each further vehicle of the set of further vehicles, calculating 121 the further vehicle condition on the basis of the further data, as schematically shown in FIG. 3, may include supplying 123a the data into a further digital twin of the further vehicle. For each further vehicle of the set of further vehicles, calculating 121 may furthermore include calculating 123b the further vehicle condition by way of the further digital twin. For each further vehicle of the set of further vehicles, calculating 121 may furthermore include storing 123c the further vehicle condition in the further digital twin.

The digital twin may be a digital representation of the vehicle. Each further digital twin may also be a digital representation of the particular further vehicle. The digital representation may in each case include a simulation which is designed to map its real correspondence (i.e., the vehicle or the particular further vehicle) as well as possible to the extent relevant for the detection and/or assessment of the intrusion on the basis of the (further) data. For each point in time of the operation of the (further) vehicle, the simulation can be expanded to this point in time and possibly compared to the (further) data. The advantage may be seen, for example, in that an understanding of the operation of the (further) vehicle is thus built up over a period of time. An intrusion may thus be detected and/or assessed more reliably than by a (real-time) intrusion detection system. As shown in FIG. 1, the digital twin (here: digital twin 1) and/or each further digital twin (here: digital twin 2, . . . ) may (but does not have to be) implemented on server 200. In the case of storing 122c, 123c the (further) vehicle condition, the (further) digital twin may function as a buffer store. Furthermore, the/each further digital twin may be used to buffer one or multiple (further) evaluation results. For example, (further) relevant driving situations may be stored, which may be used as a comparison in the detection and/or assessment of intrusions. Alternatively, the (further) digital twin may also be implemented in the (further) vehicle.

Calculating 120 the vehicle condition and/or calculating 121 each further vehicle condition may be expressed, as shown in FIGS. 4A through 4E, by a depiction 1. Such a depiction may (but does not have to) include the calculation rule from the digital twin or from the particular further digital twin.

As schematically shown in FIG. 3, method 100 may include receiving 140 at least one preceding vehicle condition at a preceding point in time, optionally from the digital twin. Detecting 130a and/or assessing 130b the intrusion into the electronic data system of the vehicle may furthermore be based at least on at least one (or multiple) preceding vehicle condition(s).

In that detecting 130a and/or assessing 130b the intrusion into the electronic data system of the vehicle is furthermore based at least on the at least one preceding vehicle condition, the result may again be expressed as a value of a function f, which is at least a function of vehicle condition Sᵥ=Sᵥ_{₁} of the vehicle and the at least one preceding vehicle condition Mᵥ=Mᵥ_{₁}:

f(Sᵥ_{₁},Mᵥ_{₁})

Such a dependency is outlined in FIGS. 4C through 4D.

If detecting 130a and/or assessing 130b the intrusion is based on multiple preceding vehicle conditions of the vehicle, the selection of these multiple preceding vehicle conditions may be implemented by a filter function g, object Mᵥ_{₁} (in a notation misuse) representing a vector of preceding vehicle conditions. Furthermore, buffered evaluation results (for example, stored relevant driving situations) may also be incorporated in object Mᵥ_{₁} (in a renewed notation misuse) and thus in the detection and/or assessment. The dependency of the result may be given by

f(Sᵥ_{₁},g(Mᵥ_{₁}))

see also FIG. 4D.

As schematically shown in FIG. 3, method 100 may include receiving 141 at least one preceding further vehicle condition at a preceding point in time, optionally from the further digital twin. Detecting 130a and/or assessing 130b the intrusion into the electronic data system of the vehicle may furthermore be based here at least on at least one preceding further vehicle condition.

In that detecting 130a and/or assessing 130b the intrusion into the electronic data system of the vehicle is furthermore based at least on at least one preceding further vehicle condition, the result may again be expressed as a value of a function f, which is at least a function of vehicle condition Sᵥ=Sᵥ_{₁} of the vehicle and the at least one preceding further vehicle condition Mᵥ_{₂}:

f(Sᵥ_{₁},Mᵥ_{₂})

If detecting 130a and/or assessing 130b the intrusion is based on multiple preceding further vehicle conditions of the further vehicle, the selection of these multiple preceding vehicle conditions may be implemented by a (further) filter function g, object Mᵥ_{₂} (in a notation misuse) representing a vector of preceding further vehicle conditions of the further vehicle. Furthermore, buffered further evaluation results (for example, stored further relevant driving situations) may also be incorporated in object Mᵥ_{₂} (in a renewed notation misuse) and thus in the detection and/or assessment. The dependency of the result may be given by

f(Sᵥ_{₁},g(Mᵥ_{₂}))

For n−1 further vehicles, with n−1>1, for example, furthermore the following dependencies of the result may result:

$$f ( {S}_{{v}_{1}} , {M}_{{v}_{1}} , {S}_{{v}_{2}} , … , {S}_{{v}_{n}} )$$

$$f ( {S}_{{v}_{1}} , {M}_{{v}_{1}} , {S}_{{v}_{2}} , {M}_{{v}_{2}} , … , {S}_{{v}_{n}} )$$

$$⋮$$

$$f ( {S}_{{v}_{1}} , {M}_{{v}_{1}} , {S}_{{v}_{2}} , {M}_{{v}_{2}} , … , {S}_{{v}_{n}} , {M}_{{v}_{n}} )$$

$$f ( {S}_{{v}_{1}} , {S}_{{v}_{2}} , {M}_{{v}_{2}} , … , {S}_{{v}_{n}} )$$

$$⋮$$

$$f ( {S}_{{v}_{1}} , {S}_{{v}_{2} ,} {M}_{{v}_{2}} , … , {S}_{{v}_{n}} , {M}_{{v}_{n}} )$$

$$f ( {S}_{{v}_{1}} , g ( {M}_{{v}_{1}} ) , {S}_{{v}_{2}} , … , {S}_{{v}_{n}} )$$

$$f ( {S}_{{v}_{1}} , g ( {M}_{{v}_{1}} ) , {S}_{{v}_{2}} , g ( {M}_{{v}_{2}} ) , … , {S}_{{v}_{n}} )$$

$$⋮$$

$$f ( {S}_{{v}_{1}} , g ( {M}_{{v}_{1}} ) , {S}_{{v}_{2}} , g ( {M}_{{v}_{2}} ) , … , {S}_{{v}_{n}} , g ( {M}_{{v}_{n}} ) )$$

$$f ( {S}_{{v}_{1}} , {S}_{{v}_{2}} , g ( {M}_{{v}_{2}} ) , … , {S}_{{v}_{n}} )$$

$$⋮$$

$$f ( {S}_{{v}_{1}} , {S}_{{v}_{2}} , g ( {M}_{{v}_{2}} ) , … , {S}_{{v}_{n} , g} , g ( {M}_{{v}_{n}} ) )$$

As schematically shown in FIG. 3, method 100 may include receiving 150 an anomaly status, which has been ascertained by the electronic data system of the vehicle (for example, by an intrusion detection system of the vehicle). Assessing 130b the intrusion into the electronic data system of the vehicle may then furthermore be based at least on the anomaly status and include: confirming 131 the anomaly status, optionally confirming the intrusion, when the at least one predetermined assessment criterion is met. Assessing 130b the intrusion into the electronic data system of the vehicle may furthermore include: refuting the anomaly status, optionally refuting the intrusion if the at least one predetermined assessment criterion is not met.

The anomaly status (or each further anomaly status, see below) may include pieces of information about the detection and/or assessment of the intrusion. The anomaly status (or each further anomaly status) may include the (preliminary) result of a detection and/or assessment of an intrusion, in particular a result of an intrusion detection system on a low integration level. For example, the anomaly status (or each further anomaly status) may include a bit for intrusion/no intrusion.

Alternatively or additionally, the anomaly status (or each further anomaly status) may include a (quasi-)continuous number (for example, in the interval of real numbers [0, 1]), which is correlated with the probability for an intrusion (for example, 0 for probability 0 or 1 for probability 1). Alternatively or additionally, the anomaly status (or each further anomaly status) may include a bit for intrusion confirmed/intrusion not confirmed. Alternatively or additionally, the anomaly status (or each further anomaly status) may include measures, for example, by way of a numeric coding of routines. The anomaly status (or each further anomaly status) may be a data structure which codes pieces of information. Alternatively or additionally, the anomaly status (or each further anomaly status) may include a numeric object, for example, a number, a vector, a matrix, or a tensor. The anomaly status (or each further anomaly status) may be coded as a byte or bit signal sequence. The anomaly status (or each further anomaly status) may be, for example, an anomaly value or a vector of the multiple anomaly values and/or intermediate results from the detection/assessment of the intrusion. Whether an anomaly is present may then be a function of the one or the multiple anomaly values (for example, anomaly value 0 means no anomaly, anomaly value 1, in contrast, designates an anomaly, average values from multiple anomaly values).

In that assessing 130b the intrusion into the electronic data system of the vehicle is furthermore based at least on the at least one anomaly status, the result may again be expressed as a value of a function f, which is a function at least of vehicle condition Sᵥ=Sᵥ_{₁} of the vehicle and the at least one anomaly status Aᵥ=Aᵥ_{₁}:

f(Sᵥ_{₁},Aᵥ_{₁})

Such a dependency is outlined in FIG. 4A.

For n−1 further vehicles, with n−1>1, for example, furthermore the following dependencies of the result may result:

$$f ( {S}_{{v}_{1}} , {A}_{{v}_{1}} , {S}_{{v}_{2}} , … , {S}_{{v}_{n}} )$$

$$f ( {S}_{{v}_{1}} , {M}_{{v}_{1}} , {A}_{{v}_{1}} , {S}_{{v}_{2}} , … , {S}_{{v}_{n}} )$$

$$f ( {S}_{{v}_{1}} , {M}_{{v}_{1}} , {A}_{{v}_{1}} , {S}_{{v}_{2}} , {M}_{{v}_{2}} , … , {S}_{{v}_{n}} )$$

$$⋮$$

$$f ( {S}_{{v}_{1}} , {M}_{{v}_{1}} , {A}_{{v}_{1}} , {S}_{{v}_{2}} , {M}_{{v}_{2}} , … , {S}_{{v}_{n}} , {M}_{{v}_{n}} )$$

$$f ( {S}_{{v}_{1}} , {A}_{{v}_{1}} , {S}_{{v}_{2}} , {M}_{{v}_{2}} , … , {S}_{{v}_{n}} )$$

$$⋮$$

$$f ( {S}_{{v}_{1}} , {A}_{{v}_{1}} , {S}_{{v}_{2}} , {M}_{{v}_{2}} , … , {S}_{{v}_{n}} , {M}_{{v}_{n}} )$$

$$f ( {S}_{{v}_{1}} , g ( {M}_{{v}_{1}} ) , {A}_{{v}_{1}} , {S}_{{v}_{2}} , … , {S}_{{v}_{n}} )$$

$$f ( {S}_{{v}_{1}} , g ( {M}_{{v}_{1}} ) , {A}_{{v}_{1}} , {S}_{{v}_{2}} , g ( {M}_{{v}_{2}} ) , … , {S}_{{v}_{n}} )$$

$$⋮$$

$$f ( {S}_{{v}_{1}} , g ( {M}_{{v}_{2}} ) , {A}_{{v}_{1}} , {S}_{{v}_{2}} , g ( {M}_{{v}_{2}} , … , {S}_{{v}_{n}} , g ( {M}_{{v}_{n}} ) )$$

$$f ( {S}_{{v}_{1}} , {A}_{{v}_{1}} , {S}_{{v}_{2}} , g ( {M}_{{v}_{2}} ) , … , {S}_{{v}_{n}} )$$

$$⋮$$

$$f ( {S}_{{v}_{1}} , {A}_{{v}_{1}} , {S}_{{v}_{2}} , g ( {M}_{{v}_{2}} ) , … , {S}_{{v}_{n}} , g ( {M}_{{v}_{n}} ) )$$

As schematically shown in FIG. 3, method 100 may furthermore include: for each further vehicle of a (second) set of further vehicles, receiving 151 a further anomaly status, which has been ascertained in each case by an electronic data system of the further vehicle (for example, by an intrusion detection system in the further vehicle). Assessing 130b the intrusion into the electronic data system of the vehicle may furthermore be based at least on at least one further anomaly status and include: confirming 132 the anomaly status, optionally confirming the intrusion and/or the at least one further anomaly status if the at least one predetermined assessment criterion is met. In this case, an intrusion into the electronic data system of the vehicle does not necessarily have to be present. Instead, an intrusion detected and confirmed in a further vehicle may be preventatively processed in the vehicle. For example, the user of the vehicle may be warned of a possible intrusion and/or prompted to seek out service (for example, for a software update). Assessing 130b the intrusion into the electronic data system of the vehicle may furthermore include: refuting the at least one further anomaly status, optionally refuting the intrusion if the at least one predetermined assessment criterion is not met. The (second) set of the further vehicles may be but does not have to be the set of the further vehicles.

In that assessing 130b the intrusion into the electronic data system of the vehicle is furthermore based at least on the at least one further anomaly status, the result may again be expressed as a value of a function f, which is at least a function of vehicle condition Sᵥ=Sᵥ_{₁} of the vehicle and the at least one further anomaly status Aᵥ_{₂}:

f(Sᵥ_{₁},Aᵥ_{₂})

For n−1 further vehicles, with n−1>1, for example, furthermore the following dependencies of the result may result:

f(Sᵥ_{₁},Aᵥ_{₁},Aᵥ_{₂})

f(Sᵥ_{₁},Aᵥ_{₁},Sᵥ_{₂},Aᵥ_{₂})

f(Sᵥ_{₁},Sᵥ_{₂},Aᵥ_{₂}, . . . ,Sᵥ_{ₙ})

f(Sᵥ_{₁},Aᵥ_{₁},Sᵥ_{₂},Aᵥ_{₂}, . . . ,Sᵥ_{ₙ})

The last-mentioned dependency is shown in FIG. 4B. Further dependencies may be:

$$f ( {S}_{{v}_{1}} , {M}_{{v}_{1}} , {S}_{{v}_{2}} , {A}_{{v}_{2}} , … , {S}_{{v}_{n}} )$$

$$f ( {S}_{{v}_{1}} , {M}_{{v}_{1}} , {S}_{{v}_{2}} , {M}_{{v}_{2}} , {A}_{{v}_{2}} , … , {S}_{{v}_{n}} )$$

$$⋮$$

$$f ( {S}_{{v}_{1}} , {M}_{{v}_{1}} , {S}_{{v}_{2}} , {M}_{{v}_{2}} , {A}_{{v}_{2}} , … , {S}_{{v}_{n}} . {M}_{{v}_{n}} )$$

$$f ( {S}_{{v}_{1}} , {S}_{{v}_{2}} , {M}_{{v}_{2}} , {A}_{{v}_{2}} , … , {S}_{{v}_{n}} )$$

$$⋮$$

$$f ( {S}_{{v}_{1}} , {S}_{{v}_{2}} , {M}_{{v}_{2}} , {A}_{{v}_{2}} , … , {S}_{{v}_{n}} , {M}_{{v}_{n}} )$$

$$f ( {S}_{{v}_{1}} , g ( {M}_{{v}_{1}} ) , {S}_{{v}_{2}} , {A}_{{v}_{2}} , … , {S}_{{v}_{n}} )$$

$$f ( {S}_{{v}_{1}} , g ( {M}_{{v}_{1}} ) , {S}_{{v}_{2}} , g ( {M}_{{v}_{2}} ) , {A}_{{v}_{2}} , … , {S}_{{v}_{n}} )$$

$$⋮$$

$$f ( {S}_{{v}_{1}} , g ( {M}_{{v}_{1}} ) , {S}_{{v}_{2}} , g ( {M}_{{v}_{2}} ) , {A}_{{v}_{2}} , … , {S}_{{v}_{n}} , g ( {M}_{{v}_{n}} ) )$$

$$f ( {S}_{{v}_{1}} , {S}_{{v}_{2}} , g ( {M}_{{v}_{2}} ) , {A}_{{v}_{2}} , … , {S}_{{v}_{n}} )$$

$$⋮$$

$$f ( {S}_{{v}_{1}} , {S}_{{v}_{2}} , g ( {M}_{{v}_{2}} ) , {A}_{{v}_{2}} , … , {S}_{{v}_{n}} , g ( {M}_{{v}_{n}} ) )$$

$$⋮$$

Detecting 130a the intrusion into the electronic data system of the vehicle may take place when the at least one predetermined detection criterion is met. In contrast, a non-intrusion may be present if the at least one predetermined detection criterion is not met.

A detected 130a intrusion and/or a confirmed (131, 132) intrusion, optionally an assessed 130b non-intrusion may be transferred into the electronic data system of the vehicle. In the case of a detected 130a intrusion and/or a confirmed (131, 132) intrusion, at least one node, optionally at least one control unit, of the electronic data system may be prompted to inform a user (for example, a driver and/or occupant) of the vehicle about the intrusion and/or to initiate a driving maneuver (for example, as a function of the result) corresponding to the intrusion.

As schematically shown in FIG. 3, receiving 110 the data of each node of the set of nodes of the electronic data system of the vehicle may include receiving 112a and decompressing 112b compressed data of each node of the set of nodes of the electronic data system of the vehicle. In this case, the data are compressed in the vehicle before sending (to server 200). The compression of the data may be lossless.

For at least one or each further vehicle of the set of further vehicles, as also schematically shown in FIG. 3, receiving 111 the further data of each node of the set of nodes of the electronic data system of the further vehicle may include receiving 113a and decompressing 113b lossless compressed further data of each node of the set of nodes of the electronic data system of the further vehicle. In this case, the particular further data are compressed in the particular further vehicle before sending (to server 200). The compression of the further data may also be lossless.

The compression of data or further data may be expressed, as shown in FIGS. 4A through 4E, by a depiction h. The compressed data may be represented with Dᵥ (or Dᵥ_{₁}).

In principle, all data (for example, result, anomaly status, . . . ), which are transferred between the vehicle and server 200 or between a further vehicle and server 200, may be compressed. Typically, results and/or the anomaly status do not occupy a large data size in comparison to the (further data) and therefore do not have to be compressed.

Furthermore, a server 200 is described in a network, which is designed to carry out computer-implemented method 100 for detecting and/or assessing an intrusion into the electronic data system of a vehicle, the electronic data system of the vehicle and, optionally, each electronic data system of each further vehicle of the set of further vehicles being connected to the network. In other words: the server may function as a connecting element between the vehicles. The network may be, for example, a radio network, in particular 4G, 5G, 6G, . . . . The vehicle and/or each further vehicle may each include a communication interface, which is designed to communicate with server 200 in the network (for example, according to a predetermined protocol). The data or the further data (for example, losslessly compressed) may thus be sent to server 200. On the other hand, server 200 may transfer back the result of the detection and/or assessment of the intrusion into the vehicle (or into a further vehicle). Server 200 may be a cloud server. As shown in FIG. 1, for example, the Vehicle Security Incident and Event Management (VSIEM) System may be implemented on server 200. The digital twin (digital twin 1 in FIG. 1) of the vehicle and, optionally, each further digital twin (for example, digital twin 2 in FIG. 1) of each further vehicle may also be implemented on server 200.

Thanks to a larger computing and/or memory capacity, server 200 may leads to more reliable detection and/or assessment of an intrusion. Furthermore, additional data (for example, software update policy, system identifier, etc., preventative broadcast of problems of the further vehicles) may be exchanged with the vehicle and/or the (further) vehicles via server 200. The additional data may be taken into consideration in the detection and/or assessment of the intrusion into the electronic data system of the vehicle.

Furthermore, a vehicle (or each further vehicle) is described which includes an electronic data system which is secured according to computer-implemented method 100 for detecting and/or assessing an intrusion into the electronic data system of the vehicle.

At least one computer program is described, which is designed to carry out computer-implemented method 100 for detecting and/or assessing an intrusion into an electronic data system of a vehicle. The computer program may be provided, for example, in interpretable or in compiled form. It may (also in parts) be loaded for execution, for example, as a bit or byte sequence into the RAM of a control unit or computer, a computer also being able to function as server 200.

Furthermore, a computer-readable medium or signal is described, which stores and/or contains the at least one computer program. The medium may include, for example, a RAM, ROM, EPROM, . . . , in which the signal is stored.

Furthermore, a computer system is described which is designed to execute the computer program. The computer system may in particular include at least one processor and at least one working memory. Furthermore, the computer system may include a memory. The computer system may extend over a system made up of the vehicle, optional further vehicles, and server 200.

What is claimed is:

1. A computer-implemented method for detecting and/or assessing an intrusion into an electronic data system of a vehicle, comprising:
receiving data from each node of a set of nodes of the electronic data system of the vehicle;
calculating a vehicle condition based on the received data;
detecting and/or assessing the intrusion into the electronic data system of the vehicle at least based on the vehicle condition.

2. The method as recited in claim 1, further comprising:
receiving, for each further vehicle of a set of further vehicles, further data from each node of a set of nodes of an electronic data system of the further vehicle;
calculating, for each further vehicle of the set of further vehicles, a further vehicle condition based on the further data of the further vehicle; and
detecting and/or assessing the intrusion into the electronic data system of the vehicle based on at least one of the further vehicle conditions.

3. The method as recited in claim 1, wherein the electronic data system of the vehicle includes a control system and at least one node of the set of nodes of the electronic data system is an electronic control unit.

4. The method as recited in claim 1, wherein the set of nodes of the electronic data system of the vehicle includes at least two nodes.

5. The method as recited in claim 2, wherein the set of the further vehicles includes at least one further vehicle.

6. The method as recited in claim 1, wherein the calculating of the vehicle condition based on the received data includes:
supplying the data into a digital twin of the vehicle; and
calculating the vehicle condition by way of the digital twin.

7. The method as recited in claim 6, wherein the calculating of the vehicle condition based on the received data further includes:
storing the vehicle condition in the digital twin.

8. The method as recited in claim 2, wherein, for each further vehicle of the set of further vehicles, the calculating of the further vehicle condition based on the further data includes:
supplying the data into a further digital twin of the further vehicle; and
calculating the further vehicle condition by way of the further digital twin.

9. The method as recited in claim 8, wherein the calculating of the further vehicle condition based on the further includes storing the further vehicle condition in the further digital twin.

10. The method as recited in claim 1, further comprising:
receiving at least one preceding vehicle condition at a preceding point in time, wherein the detecting and/or assessing of the intrusion into the electronic data system of the vehicle is further based at least on the at least one preceding vehicle condition.

11. The method as recited in claim 2, further comprising:
receiving at least one preceding further vehicle condition at a preceding point in time, wherein the detecting and/or assessing of the intrusion into the electronic data system of the vehicle is further based at least on the at least one preceding further vehicle condition.

12. The method as recited in claim 1, furthermore comprising:
receiving an anomaly status, which has been ascertained by the electronic data system of the vehicle, wherein the assessing of the intrusion into the electronic data system of the vehicle is based at least on the anomaly status; and
confirming the anomaly status when at least one predetermined assessment criterion is met.

13. The method as recited in claim 1, wherein the detecting of the intrusion into the electronic data system of the vehicle takes place when at least one predetermined detection criterion is met.

14. The method as recited in claim 1, wherein a detected intrusion and/or a confirmed intrusion is transferred into the electronic data system of the vehicle.

15. The method as recited in claim 14, wherein in the case of a detected intrusion and/or a confirmed intrusion at least one node of the electronic data system is prompted to inform a user of the vehicle about the intrusion and/or to initiate a driving maneuver corresponding to the intrusion.

16. A server in a network configured to detect and/or assess an intrusion into an electronic data system of a vehicle, the server configured to:
receive data from each node of a set of nodes of the electronic data system of the vehicle;
calculate a vehicle condition based on the received data;
detect and/or assess the intrusion into the electronic data system of the vehicle at least based on the vehicle condition;
wherein the electronic data system of the vehicle is connected to the network.

17. The server as recited in claim 16, wherein a digital twin of the vehicle is implemented on the server.

18. A vehicle, which includes an electronic data system, which is secured according to a computer-implemented method for detecting and/or assessing an intrusion into the electronic data system of the vehicle, the computer-implemented method comprising:
receiving data from each node of a set of nodes of the electronic data system of the vehicle;
calculating a vehicle condition based on the received data;
detecting and/or assessing the intrusion into the electronic data system of the vehicle at least based on the vehicle condition.
